(19) United States
(12) Patent Application Publication
(10) Pub. No.: US 2010/0236906 A1
(43) Pub. Date: Sep. 23, 2010

(54) METHOD AND DEVICE FOR SWITCHING ELECTRICAL APPLIANCES

(76) Inventor: Frank Fischer, Gomaringen (DE)

Correspondence Address: KENYON & KENYON LLP, ONE BROADWAY, NEW YORK, NY, 10004, US

(21) Appl. No.: 12/669,791

(22) PCT Filed: Jun. 13, 2008
(86) PCT No.: PCT/EP08/57492

§ 371 Date: Jun. 7, 2010

(30) Foreign Application Priority Data
Jul. 16, 2007 (DE) 10 2007 033 004.0

(51) Int. Cl. H01H 35/14

(52) U.S. Cl. 200/61.45 R

(57) ABSTRACT

Exemplary methods and devices of an electrical operating device, an electrical appliance having an electrical operating device, and a method for switching an electrical appliance, are provided. For example, an electrical operating device embodiment may include an acceleration sensor, an electrical switching means, an electric line, and a signal line. The signal line may be associated with the acceleration sensor and the electrical switching means. The acceleration sensor may be designed so that at a predefinable acceleration, a signal is generated by which the electrical switching means is activated. The electric line is switchable using the electrical switching means.

### FIELD OF INVENTION

The present invention relates generally to methods and devices for switching an electrical appliance.

### BACKGROUND INFORMATION

Few protective methods are known for electrical appliances, in which the operating mode is changed in response to a free fall or a supercritical (impact) acceleration, so as to avoid possible consequential damage. For example, in the case of hard disks, data integrity may be improved if, as a reaction to a free fall, protective measures are initiated. Such protective measures may include interruption of the writing process, parking the read/write head in a protected position, and stopping the hard disk motor).

### SUMMARY

Embodiments of the present invention describe a method and a system by which the operating and working integrity of electrical appliances is able to be improved.

Embodiments of the present invention relate to an electrical operating device. In an embodiment, the electrical operating device is provided with an acceleration sensor, an electrical switching means and an electric line. In an embodiment, the electrical operating device is also provided with a signal line which is connected to the acceleration sensor and the electrical switching means. The acceleration sensor is designed, in this instance, in such a way that at a predefinable acceleration a signal is generated by which the electrical switching means are able to be activated. The electric line is able to be switched using the electrical switching means. Embodiments of the present invention provide for such an acceleration-dependent operating device for an electric line.

Embodiments of the electrical operating device of the present invention provide that the electric line is disconnectible using the electrical switching means. Here, for example, such an acceleration-dependent cut-out switch is created for an electric line. In an embodiment of the electrical operating device, the electric line is a voltage supply line. In such an embodiment, in the case of specifiable acceleration, the voltage supply may be switched on or off.

In an embodiment of the present invention of the electrical operating device provides that at least the acceleration sensor and the electrical switching means are situated in a common housing. In an embodiment of the present invention, at least the electrical switching means are shut off liquid-tight from the environment.

According to embodiments of the present invention, an acceleration-sensitive sensor is used in an electrical appliance, which is in a position to detect or make detectable a situation that is unusual to the application, so that protective measures may be induced that are able to protect the operator, the operator's immediate surroundings, or the appliance from consequential damage. Such protective measures are, for example, the change to a mode of reduced operation or operational readiness, switching off high-voltage regions, the galvanic interruption of the voltage supply, or the like.

Embodiments of the present invention relate to an electrical appliance having an electrical operating device. The electrical appliance includes an electrical operating device according to the present invention, the electrical appliance also having an electric load connected to the electric line. In an embodiment, the electrical appliance is switchable between different operating states, dependent upon the acceleration.

Embodiments of the present invention relate to a method for switching an electrical appliance, including:
(a) operating the appliance in a first operating state,
(b) measuring an acceleration acting on the appliance during step (a),
(c) switching the electrical appliance for operation in a second operating state and, as soon as a specifiable acceleration is measured in step (b),
(d) evaluating the state of the appliance during step (c),
(e) returning to step (a) in response to a result of the evaluation of the state corresponding to a specification.

In embodiments of the present invention, the method provides that if, in step (e), there is a result of the evaluation of the state that differs from the specification, the appliance continues to be operated in the second operating state. In embodiments of the present invention, the method provides that, in step (d), to evaluate the state of the appliance, the acceleration acting upon the appliance is measured again. In embodiments of the present invention, the method provides that, in step (d), the evaluation of the state of the appliance is undertaken manually, using input means.

### BRIEF DESCRIPTION OF THE DRAWINGS

FIG. 1 shows a schematic of an electrical appliance of the related art.

FIG. 2 shows an exemplary embodiment of an electrical appliance according to the present invention having an operating device that is dependent on acceleration.

FIG. 3 shows an exemplary embodiment of an electrical appliance according to the present invention having an operating device that is dependent on acceleration.

FIG. 4 shows an exemplary embodiment of an electrical operating device according to the present invention.

FIG. 5 shows a schematic of an exemplary method according to the present invention for switching an electrical appliance.

### DESCRIPTION OF EXEMPLARY EMBODIMENTS

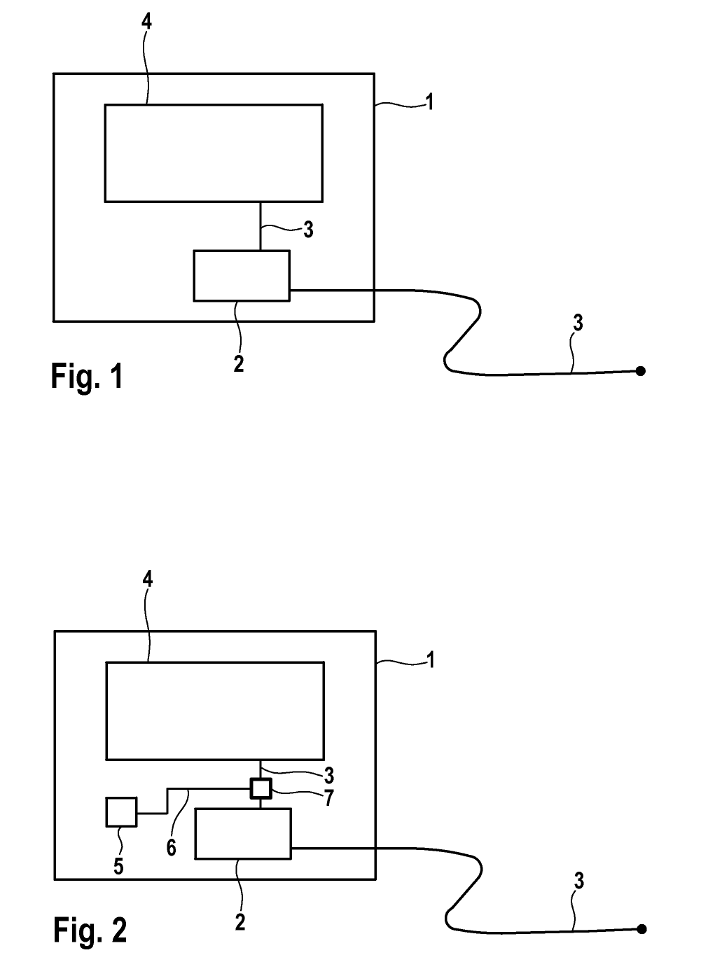

FIG. 1 shows schematically an electrical appliance according to the related art. An electrical or electronic appliance 1 having an electric load 4 is connected directly via a voltage supply line 3 or via a transformer 2 to the central voltage supply (power supply system). In the case of a situation that is not typical for the application, such as an impact after a fall, a current-conducting line within appliance 1 may be damaged, and may generate a short circuit to sensitive circuit components, but also to conductive parts, and to housing parts of appliance 1 that are accessible from the outside. The user and the user's surroundings may be endangered by this.

FIG. 2 shows an exemplary embodiment of an electrical appliance according to the present invention, having an operating device that is dependent on acceleration. In an embodiment of the present invention, in an electronic appliance connected to the central voltage supply in the form of a network connection, either directly or via a transformer 2, using an electric line 3, an acceleration sensor 5 is integrated, which is able to switch off the voltage supply of a load 4 using a switching means 7 via a signal line 6, if critical acceleration values have been detected. In an embodiment, switching means 7 is an interrupter circuit which interrupts electric line 3 upon a signal present at signal line 5. In an embodiment, a critical value of the acceleration may occur in response to a free fall, perhaps dampened by the connection to a cable, since a free fall of an appliance is typically followed by an impact. During a free fall, for example, acceleration values of clearly less than 1 g may be detected in all spatial directions. In embodiments, sudden changes in acceleration may also be used as a criterion for an emergency shutdown, as may high accelerations (e.g., greater than 1.5 g) occurring suddenly during operation. In embodiments, the sensor may be supplied with current from an accumulator or a battery, but a suitable voltage supply that is already present in load 4 or another component of appliance 1 may also be utilized. In an embodiment of the present invention, the electrical interruption in the switching means 7 is able to be canceled again using a switch (not shown), if the voltage supply had been interrupted after an event, and the appliance is to be reactivated for further utilization. In an embodiment, the switching means 7 may also be mounted outside the appliance, for example, in the power plug at the end of the electric line 3, close to the connection to the central voltage supply. In this example, the sensor 5 is connected to the switching means 7, using a control line 6 which is run inside or on the cable of the electric line 3.

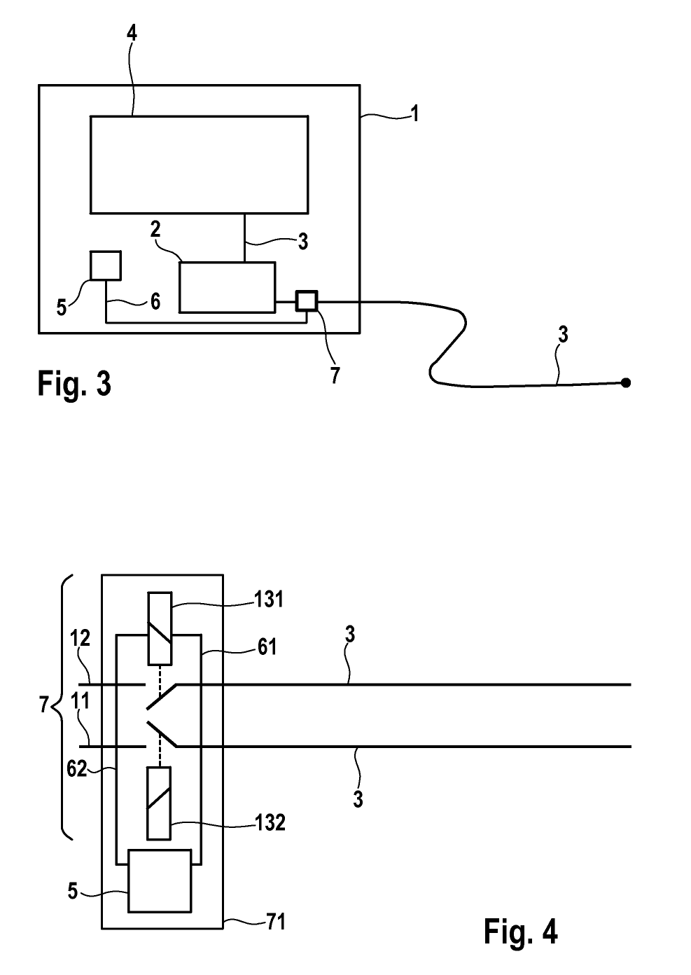

FIG. 3 shows an exemplary embodiment of an electrical appliance according to the present invention having an operating device that is dependent on acceleration.

Alternatively to the exemplary embodiment according to FIG. 2, in FIG. 3 the switching means 7 is situated before transformer 2, so that the voltage supply is able to be interrupted by electric line 3 using switching means 7, before transformer 2.

FIG. 4 shows an exemplary embodiment of an electrical operating device according to the present invention. FIG. 4 shows a schematic representation of an operating device 71. In this exemplary representation, two electric lines 3 are run from the central voltage supply to the switching means 7. Within switching means 7, interrupter elements 131 and 132 are situated, such as electromagnetic relays or other elements by which a voltage supply may be interrupted. The control of interrupter elements 131 and 132 takes place by an acceleration-sensitive sensor 5, via signal lines 61 and 62.

In this example, sensor 5 and signal lines 61 and 62, as well as switching means 7, that is, all the essential elements of operating device 71 for purposes of this example, are positioned inside a common assembly. According to FIG. 2 or FIG. 3, in alternative specific embodiments, sensor 5 may also be situated separately from switching means 7. Because of the interrupter elements 131 and 132, electric lines 3 may be separated if sensor 5 detects a critical situation and emits a signal to interrupter elements 131 and 132 via signal lines 6.

In an embodiment of the present invention, interrupter unit 7 is developed to be waterproof. Using this embodiment, it is possible to switch off an electrical appliance, such as a hair dryer, before it comes into contact with a liquid, for example, because of an impact or a fall, and consequently to separate the voltage supply from the liquid galvanically. A hair dryer may thus be switched off before it falls, for example, into a bathtub filled with water, and may safely remain switched off under water, because switching means 7 is shut off from the surroundings in a liquid-tight manner.

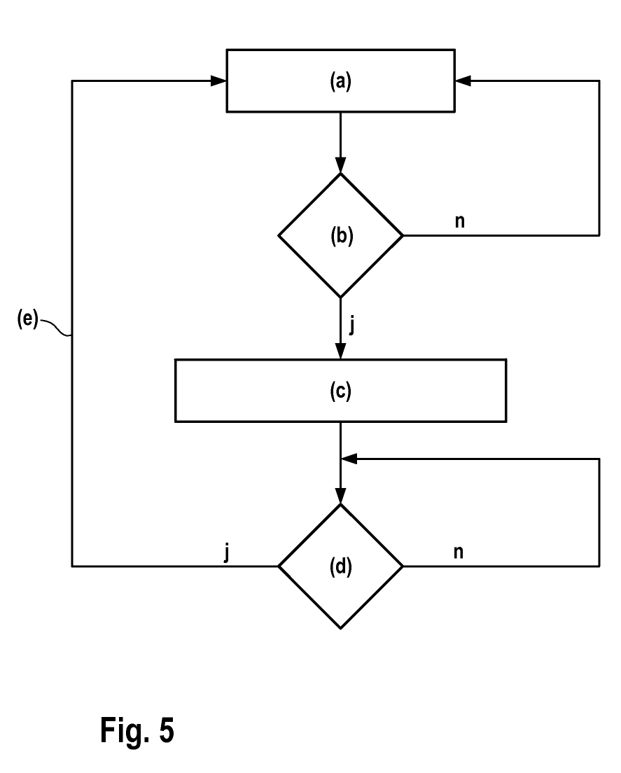

FIG. 5 shows schematically an exemplary method according to the present invention for switching an electrical appliance. An embodiment includes:
(a) operating the appliance in a first operating state,
(b) measuring an acceleration acting on the appliance during step (a),
(c) switching the electrical appliance for operation in a second operating state, as soon as a specifiable acceleration is measured in step (b),
(d) evaluating the state of the appliance during step (c), and
(e) returning to step (a) in response to a result of the evaluation of the state corresponding to a specification.

In an embodiment, in step (e), if there is a result of the evaluation of the state that differs from the specification, the appliance continues to be operated in the second operating state.

In an embodiment, in step (d), to evaluate the state of the appliance, the acceleration acting upon the appliance is measured again.

An alternative embodiment of the method, according to the present invention, provides that in step (d) the evaluation of the state of the appliance is undertaken manually, using input means. The user of the appliance presses a switch, for example, when everything is in order, and is able to use the appliance again.

1-10. (canceled)

11. An electrical operating device, comprising:
an acceleration sensor;
an electrical switching means;
an electric line; and
a signal line,
wherein the signal line is connected to the acceleration sensor and the electrical switching means, the acceleration sensor being designed in such a way that, at a predefinable acceleration, a signal is generated by which the electrical switching means are able to be activated, the electric line being switchable using the electrical switching means.

12. The electrical operating device as recited in claim 11, wherein the electric line is disconnectible using the electrical switching means.

13. The electrical operating device as recited in claim 11, wherein the electric line is a voltage supply line.

14. The electrical operating device as recited in claim 11, wherein at least the acceleration sensor and the electrical switching means are situated in a common housing.

15. The electrical operating device as recited in claim 11, wherein at least the electrical switching means is shut off from its surroundings in a liquid-tight manner.

16. An electrical appliance, comprising:
an electrical operating device having:
an acceleration sensor;
an electrical switching means;
an electric line; and
a signal line,
wherein the signal line is connected to the acceleration sensor and the electrical switching means, the acceleration sensor being designed in such a way that, at a predefinable acceleration, a signal is generated by which the electrical switching means are able to be activated, the electric line being switchable using the electrical switching means; and
an electrical load connected to the electric line.

17. A method for switching an electrical appliance, comprising:
(a) operating the appliance in a first operating state;
(b) measuring an acceleration acting on the appliance during step (a);
(c) switching the electrical appliance for operation in a second operating state as soon as a specifiable acceleration is measured in step (b);
(d) evaluating the state of the appliance during step (c); and
(e) returning to step (a) in response to a result of the evaluation of the state corresponding to a specification.

18. The method as recited in claim 17, wherein the appliance continues to be operated in the second operating state in step (e) in response to a result of the evaluation of the state that deviates from the specification.

19. The method as recited in claim 17, wherein, in step (d), an acceleration acting on the appliance is measured again to evaluate the state of the appliance.

20. The method as recited in claim 17, wherein, in step (d) the evaluation of the state of the appliance is undertaken manually using input means.
